(19) United States
(12) Patent Application Publication
(10) Pub. No.: US 2006/0237050 A1
(43) Pub. Date: Oct. 26, 2006

(54) Dishwasher collection chamber filter cleaning system

(75) Inventors: David Clinton Weaver, Greenwood, MS (US); Jerry Wayne Ferguson, Greenwood, MS (US); John Frederick Morrison, Greenwood, MS (US); John Patrick Picardat, Greenwood, MS (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/113,714

(22) Filed: Apr. 25, 2005

(51) Int. Cl. B08B 7/04; B08B 3/00; B08B 9/20; B08B 3/04; B08B 3/12

(52) U.S. Cl. 134/56 D; 134/58 D; 134/184; 134/104.2; 134/25.2; 134/10; 134/18

(57) ABSTRACT

A dishwasher incorporates a primary filter cleaning system for removing food debris from circulated wash water. The dishwasher having a sump formed in the floor of the dishwasher and a wash pump having an inlet in communication with the sump. A collection chamber is formed in the bottom of the sump and comprises at least one wall having filter media. A sprayer is disposed within the collection chamber and is in fluid communication with the pump. The sprayer has at least one nozzle aligned for spray contact with the filter media. When water is pumped from the sump to sprayer, the water is sprayed across the filter media to remove any debris from the filter media.

### FIELD OF THE INVENTION

The present invention relates generally to a dishwasher, and, more particularly, to a dishwasher that incorporates a filter cleaning system for a food debris collection chamber.

### BACKGROUND OF THE INVENTION

Conventional dishwashers utilize a drain and refill system that fills a dishwasher tub with fresh water at the beginning of the wash cycle to mix with and remove food debris from dishes. The cycle begins by drawing water through a pump that is operated by a motor and forces the water back onto the dishes through one or more spray arms. However, the fresh water becomes soil-laden as the food debris is removed from the dishes. The dishwashing cycle continues with the soil-laden water drawn into the pump through the pump inlet and sprayed back over the surface of the dishes. The dishwasher cycle then drains the soil-laden water from the dishwasher tub and repeats the cycle by refilling the tub with fresh water. This drain and refill sequence typically is based on a timed cycle with the draining occurring at a preset point in the overall wash cycle. This sequence repeats until the “dilution ratio” of fresh water to soil-laden water becomes high enough for the dishes to be considered relatively clean. However, the relative cleanliness of the dishes is based largely on the number of times the dishwasher drains the soil-laden water and refills the tub with fresh water.

Present dishwashers are equipped with one of two general types of filtration systems. The first and most desirable type of filtration system is one in which all of the wash water passes through a filter. The second type of filtration system utilizes partial flow filters in which only a portion of the water being pumped by the wash pump is filtered. This second type is somewhat inefficient and ineffective since a portion of the suspended debris is re-pumped through the spray arms and back onto the dishes without first being filtered.

Even a 100-percent, full, filter system of the first type can still leave food debris on the dishes and on the interior surfaces of the dishwasher after pump-out, i.e. when the wash water is pumped out of the dishwasher. If the food debris screened or strained by the primary filter does not have a place to be collected and stored during intermediate phases of the wash cycle, much of the strained debris will remain spread around the bottom of the dishwasher tub as the water level recedes during pump-out. When the dishwasher fills with water for the next wash phase, any food debris that remains inside the dishwasher will be mixed with the fresh water of the next fill.

In order to contain the strained food debris in a relatively confined space so it can be efficiently removed from the dishwasher tub during pump-out at the end of the wash phase, some dishwashers with filtration systems use a “collection chamber,” which, as used herein, refers to a cavity or container where food debris is collected during the wash cycle. Typically, the collection chamber is positioned so that when the dishwasher drain phase begins, all of the wash water is drawn or pumped out through the collection chamber. Pump-out through the collection chamber tends to draw or force out the collected food debris with the wash water.

If the water that suspends the food debris within the collection chamber was allowed to exit the collection chamber during the wash cycle, while leaving the debris behind, then more solid debris could be collected in the chamber. This is especially true of debris which has a specific gravity similar to or less than water; i.e., the debris floats. In order to allow the water to exit the collection chamber, fine filter screens are sometimes employed in the walls of the collection chamber. These screens provide a path for water to return to the sump, while keeping most of the debris trapped within the collection chamber. With such an arrangement, however, the food debris in the chamber may gradually block the fine filter screens that comprise all or parts of the walls of the collection chamber.

In order to clean the fine filters of the collection chamber, some dishwashers have mounted cleaning jets on the underside of the lower spray arm. However, this approach has been largely ineffective since the underside of the lower spray arm moves in a circular path as the spray arm rotates. This circular rotation makes alignment of the cleaning jets with the walls of the collection chamber difficult. Further, the cleaning jets can only operate effectively when the lower spray arm is fully pressurized.

What is needed is a cleaning system for the fine filter screens of the dishwasher collection chamber that precisely and effectively sprays food debris away from the filter media. The cleaning system should allow filtered wash water to return to the sump for recirculated use, yet operate independently of the moving spray arms or spray arm supports of the dishwater.

### SUMMARY OF THE INVENTION

The present system addresses these and other drawbacks of prior dishwashers by providing a filter cleaning system for removing food debris from the fine filters of a collection chamber in a dishwasher having either a full or partial-flow primary filtration system. Generally, the dishwasher includes a cabinet having opposed side walls, a rear wall, a pivotal front door, a top wall, and a floor. A sump is formed in the floor and a wash pump having a pump inlet is in fluid communication with the sump.

A collection chamber is formed in, and extends through, the bottom of the sump and comprises a bottom, an open top, and at least one wall that extends upwardly from the bottom of the sump. Some or all of the walls are formed of fine mesh filters. A sprayer is situated within the collection chamber, the sprayer being in fluid communication with the pump and including at least one nozzle aligned for spray contact with the filter media. As used herein, “sprayer” refers to any device suitable for discharging a jet of liquid under pressure. As those skilled in the art will appreciate, these devices may be movable or fixed, and may be installed in a variety of configurations. Also, as used herein, “jet” refers to a fluid stream forced out of a reduced diameter opening or nozzle.

When water is pumped from the sump to the sprayer, the water is sprayed across the filter to remove any food debris thereon. In one preferred embodiment, apertures are formed through the wall of a conduit, generally spaced apart vertically to form multiple nozzles. The conduit may be a stationary tube that extends upwardly from the bottom of the collection chamber. A drain pump may optionally be provided for permanent removal of debris collected within the collection chamber.

Generally, the dishwasher further includes upper and lower spray arms that are in fluid communication with the pump. A multi-position flow control valve is placed downstream of the pump discharge whereby the valve is selectively positionable to direct wash water flow to at least one of the sprayer, the lower spray arm, and the upper spray arm. The multi-position flow control valve may be positioned to direct all wash water flow from the pump to the sprayer.

A second aspect of the present invention is directed to a method of operating a dishwasher to clean debris from the filter media of the collection chamber. The method comprises the steps of pumping filtered water through a wash water pump, and selectively directing the filtered water to either the sprayer, the lower spray arm, or the upper spray arm, or a combination thereof.

A further aspect of the present invention is directed to a method of controlling the flow of circulated, filtered wash water in a dishwasher having a lower spray arm, an upper spray arm, and a fine filter sprayer. Here, filtered water is pumped through the wash water pump and an electronic controller selectively directs the filtered water to the lower spray arm, upper spray arm, fine filter sprayer, or any combination of these.

These and other aspects of the present invention will become apparent to those skilled in the art after a reading of the following description when considered with the drawings.

### BRIEF DESCRIPTION OF THE DRAWINGS

FIG. 1 is a front perspective view of the dishwasher.

FIG. 2 is a schematic view of the dishwasher of FIG. 1, illustrating the collection chamber and fine filter cleaning system.

FIG. 3 is a top view of the collection chamber fine filter cleaning system of FIG. 2.

FIG. 4. is a side view of a multi-positional valve.

FIG. 5 is a top cutaway view of the valve of FIG. 4.

### DETAILED DESCRIPTION

Certain exemplary embodiments of the present invention are described below and illustrated in the attached Figs. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art, and all such alternate embodiments, modifications and improvements are within the scope of the present invention.

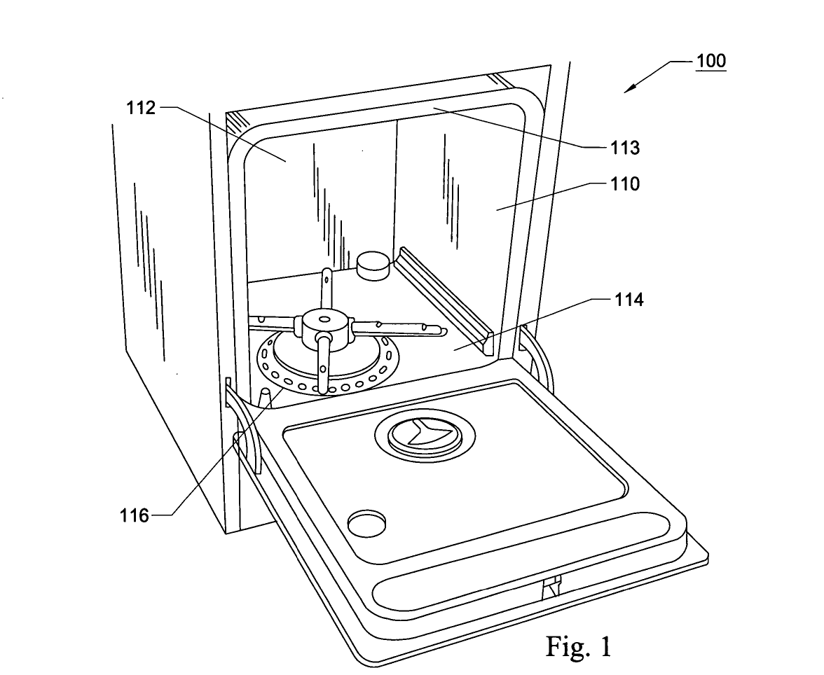

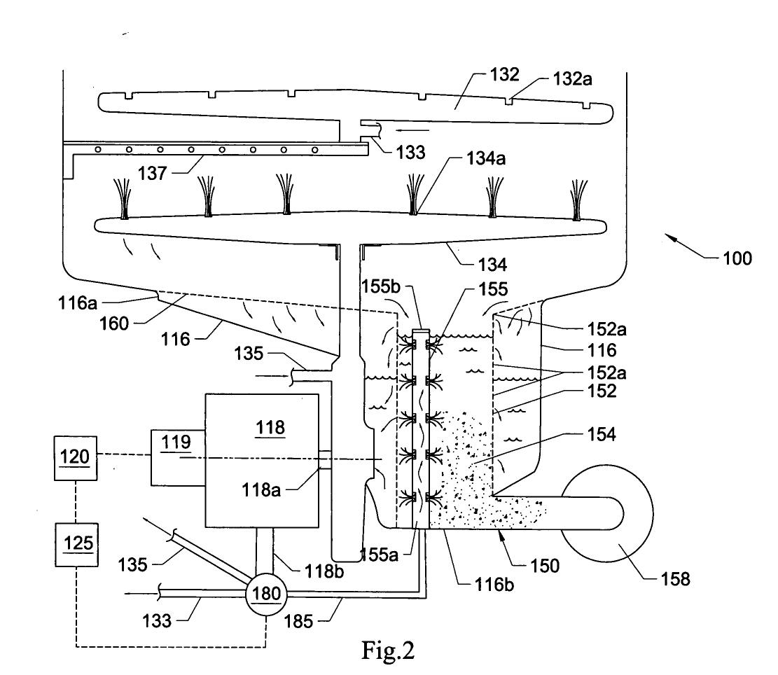

Referring to the figures in general, and FIGS. 1 and 2 in particular, a dishwasher 100 is shown. The dishwasher 100 includes opposed side walls 110, a rear wall 112, a top wall 113, and a floor 114. A sump 116 is formed in the floor 114, or tub, of the dishwasher 100. A conventional wash pump 118 is situated on level with or below the sump 116 and includes a wash water inlet 118a that is in fluid communication with the lower portion of the sump 116. The wash pump 118 is electrically connected to an electronic motor controller 120 via a motor 119, which controls the wash cycle sequence during operation of the dishwasher 100. As is also conventional in many current dishwasher constructions, the pump 118 supplies filtered, recirculated wash water to an upper spray arm 132 and a lower spray arm 134, as will be described in greater detail below.

A primary filter 160 comprising mesh wire or mesh plastic screen is affixed over the open top of the sump 116. The primary filter 160 is positioned to filter out food debris removed from the debris-laden dishes that are larger than the individual openings in the primary filter 160. The smaller the openings in the filter, the larger the volume of debris that will be filtered from the dirty dishwater. To keep the primary filter 160 from clogging and blocking the flow of wash water therethrough, various constructions have been developed for cleaning the primary filter via pressurized jets to sweep debris off of the primary filter.

As shown in FIG. 2, the primary filter 160 may be sloped downwardly and inwardly from the upper periphery 116a of the sump 116 to the open top 152a of a collection chamber 150. The filter 160 need not be sloped in such manner, but is shown in FIG. 2 as one available orientation. The collection chamber 150 is formed through the bottom of the sump and comprises a tubular-shaped cavity 152 that projects upwardly from the bottom of the sump 116. Because the support, or pedestal, for the lower spray arm typically extends upwardly from the bottom of the dishwasher, the collection chamber of the dishwasher described herein is located off-center of the dishwasher so that debris is more effectively swept into the collection chamber. The upper spray arm 132 is supported from the sidewall of the dishwasher by a bracket 137. The collection chamber 150 has a lower portion 154 that provides a volume for receiving and temporarily holding solid debris apart from the recirculated wash water during the dishwashing cycle. At the end of a complete washing cycle, a drain pump 158 pumps or otherwise removes the solid debris and any residual water within the collection chamber 150 through a connected drain hose (not shown). The upper portion of the cavity 152 of the collection chamber 150 may further comprise one or more fine filter screens 152a that enable wash water to transport the debris in collection chamber 150 to return through the fine filter screens 152a to the sump 116 for subsequent recirculation.

A sprayer 155 is disposed within the collection chamber 150 and extends upwardly into the cavity 152 of the collection chamber 150. The sprayer 155 is in fluid communication with the wash pump 118. In one embodiment, the sprayer 155 comprises a stationary conduit 155a, or tube, that extends upwardly through the bottom of the collection chamber 150. The upper end of the conduit is closed with an end cap 155b or equivalent closure piece.

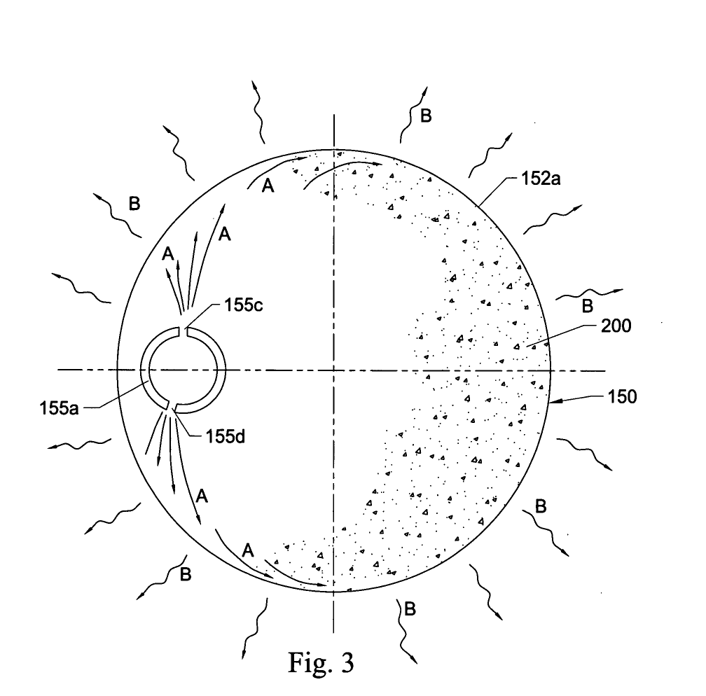

Apertures are formed through the wall of the conduit 155a to define a plurality of spray nozzles 155c. As shown in FIG. 2, the spray nozzles 155c are spaced apart vertically along the length of the conduit 155a. The actual number of spray nozzles is dependent upon the height of the collection chamber 150 and on the number and placement of the fine filter screens 152a that comprise at least part of the wall of the collection chamber 150. As shown in FIG. 3, the nozzles may be formed in opposed pairs 155c, 155d so that jets of cleaning water are directed outwardly against the curved surfaces of the fine filter screens 152a as shown by Arrows ‘A’. Because the fine screens 152a are convex with respect to the position of the conduit 155a, the water is generally urged to flow along, and outwardly through the screens 152a as shown by Arrows ‘B’. The force and angle of the jets of water thus sweeps any accumulated debris, shown generally as 200, off the surfaces of the screens and into the volume of the collection chamber 150. Those skilled in the art will appreciate that the present cleaning system may comprise more than one conduit 155a, conduits of different cross-section, and various patterns of jet nozzles to accomplish satisfactory cleaning of the fine screens 152a from within the collection chamber 150.

The pump 118 of the present invention pumps the filtered wash water from the sump 116 and discharges all of the water by way of a discharge line 118b to a multi-position flow control valve 180. The multi-position flow control valve 180 is configured to be selectively positionable to direct flow to the sprayer 155, the lower spray arm 134, the upper spray arm 132, all three, or any combination of these. The electronic motor controller 120 is electrically connected to a dishwasher flow controller 125. The dishwasher controller 125 is electrically connected to the multi-position flow control valve 180 to control how and where the valve directs the filtered wash water flow. Separate discharge lines direct flow to the selected cleaning/spraying mechanisms. For example, line 185 directs flow from the valve 180 to the fine filter cleaning conduit 155a, line 133 directs flow from the valve 180 to the upper spray arm 132, and line 135 directs flow from the valve 180 to the lower spray arm 134.

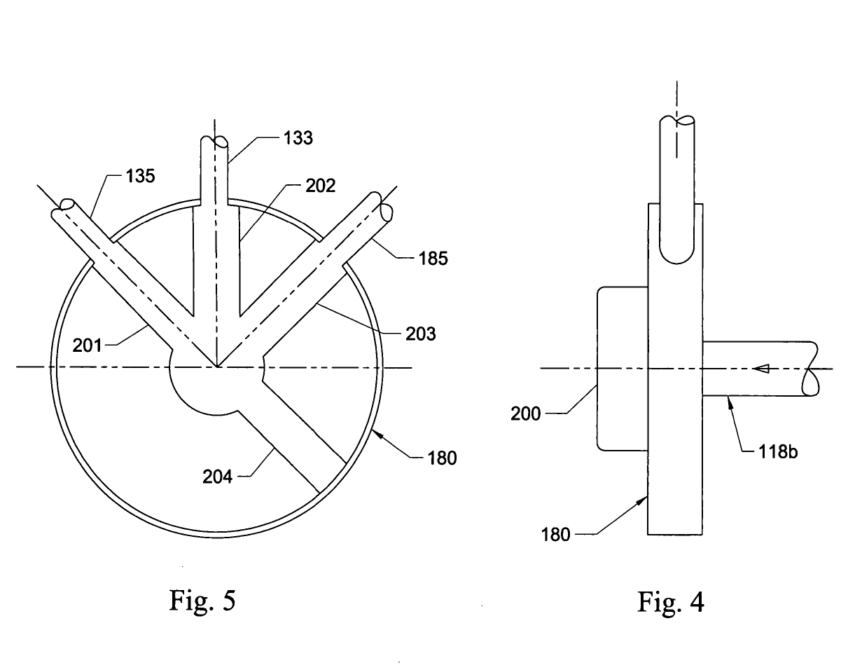

The side view of the multi-positional valve 180 shown in FIG. 4 illustrates that the valve 180 has a drive motor 200 that is controlled by the controller 125. The inlet to the multi-positional valve 180 is through the inlet line 118b from the pump 118. The valve 180 then has the three outlet lines 133, 135, and 185 as previously described. FIG. 5 is a cross sectional view of the valve 180 illustrating how the water flow may be directed to any one of the three outlet lines 133, 135, or 185 or any combination of these lines. The drive motor 200 can rotate through a central series of passageways 201, 202, 203, and 204. These passageways are connected to the inlet line 118b. As seen in FIG. 5, passageway 201 aligns with line 133, passageway 202 aligns with line 135, and passageway 203 aligns with line 185. In this configuration, water is supplied to all three outlet lines 133, 135, and 185. The line 204 is generally a shutoff switch, and in the configuration shown in FIG. 5, is shown as blocked against the wall of the valve 180. Passageways 201-204 can be rotated by the drive motor 200 to give a variety of flow combinations. For example, to supply water only to the lower spray arm 134 through the line 135, the passageway 204 is aligned with the line 133. If this rotation takes place, the passageways 201, 202, and 203 would be blocked against the wall of the valve 180 and could not supply any water. In order to only supply the upper spray arm 132, through its line 133, passages 201-204 are rotated again to align passage 204 with line 133. In this situation, liquid is supplied only through the line 133 because the passageways 201, 202, and 203 are blocked against the side of the valve 180. Finally, to supply only the fine filter cleaning conduit 155, passageways 201-204 would be rotated to bring passageway 201 into alignment with line 185. In this configuration, passageways 202, 203, and 204 would be blocked against the wall of the valve 180 and liquid would be supplied only through line 185. Thus, various combinations of flows are possible to supply water to either of, or all of, spray arms 134 and 132 and/or the fine filter cleaning conduit 155.

If desired, the multi-positional valve 180 can be replaced by individual valves, all of which would be controlled by the system controller 125. However, a single multi-positional valve such as 180 is preferred to simply operation and construction.

As the dishwashing cycle progresses, the primary filter 160 gradually becomes covered and blocked by the food debris being washed from the dishes. As described hereinabove, currently known dishwashers incorporate a primary filter cleaning mechanism. Conventional mechanisms most often comprise downwardly directed spray jets that are formed in the bottom of the dishwasher's lower spray arm.

As debris is swept into the collection chamber 150, the more dense particles settle to the bottom of the collection chamber 150 and the wash water that flowed into the collection chamber with the debris then passes through the fine filter screens 152a into the sump 116 for subsequent recirculation. The water level in the collection chamber 150 tends to be higher than in the surrounding sump because water from the primary filter cleaning system and from the conduit 155a tends to collect in the collection chamber 150.

The present system remedies this conventional problem. As the fine filter screens 152a become clogged, filtered cleaning water may be directed independently to the sprayer 155. The multi-position valve 180 is able to stop flow to the spray arms 132, 134 and instead direct all flow to the stationary conduit 155a. By stopping flow to the spray arms, only the cleaning nozzles of the fine filter screen sprayer require flow. Thus, the maximum amount of available water volume and pressure is delivered to the cleaning nozzles 155c, 155d. As the fine filters 152a are cleared of debris, the dishwasher controller 125 can selectively restore flow to the spray arms, while stopping or reducing flow to the sprayer 155.

In operation, the wash pump 118 directs wash water flow to the upper and lower spray arms 132, 134 during the normal dishwashing cycle. The upper and lower spray arms each have spaced nozzles 132a, 134a that project upwardly for washing action on the dishes in the upper and lower dish racks (not shown), respectively, as the spray arms rotate. In many instances, the dishes will be heavily laden with food debris that must be cleaned away. The washing action of the spray arms washes the food debris from the dishes, with the soiled water and debris proceeding downwardly to the tub of the dishwasher. As the water passes through the primary filter 160 that covers the top of the sump 116, larger particles of food debris are screened out. The filtered wash water that is collected in the sump 116 is then drawn back through the wash water pump 118 and the cycle is repeated until a final rinsing step is completed with fresh water. Another aspect of the present invention is directed to a method of operating a dishwasher to sweep debris from the fine filters 152a of the collection chamber 150. The method comprises a step of pumping filtered water from the dishwasher sump to a stationary conduit 155a that extends upwardly into the conduit proximate the level of the fine filters 152a. The conduit 155a has a plurality of spaced nozzles 155c 155d directed against the convex surface of the fine filters 152a. The filtered water is then sprayed across the fine filters, sweeping debris from the fine filters and into a collection chamber.

Yet another aspect of the present invention is directed to a method of controlling the flow of circulated, filtered wash water in a dishwasher having a lower spray arm 134, an upper spray arm 132, and a fine filter sprayer 155. Here, filtered water is pumped thorough the wash water pump 118. The pump then selectively directs the filtered water to the lower spray arm, upper spray arm, fine filter sprayer, and/or any combination of these. The flow to these mechanisms is controlled by a multi-position flow control device 180. During the normal washing cycle, all of the flow is directed to the upper and lower spray arms to accomplish the wash function. This is the flow scheme when the fine filters 152a are not overly loaded or blocked by debris. As the fine filters 152a become substantially blocked, all of the flow is selectively directed to the sprayer, wherein a higher flow rate, and thus a higher water pressure is delivered to the fine filter sprayer for sweeping of the debris from the fine filter media and into the collection chamber.

While the invention has been disclosed in its preferred forms, it will be apparent to those skilled in the art that many modifications, additions, and deletions can be made therein without departing from the spirit and scope of the invention or its equivalents as set forth in the following claims.

We claim:

1. A dishwasher incorporating a cleaning system for removing debris build-up from fine filter surfaces of a debris collection chamber, the dishwasher comprising:
a floor, a sump formed in the floor, and a wash pump having a pump inlet in communication with the sump and a pump discharge, the sump having a bottom;
a collection chamber formed in the bottom of the sump, the collection chamber having an open top and comprising at least one wall, at least part of the at least one wall comprising filter media;
a sprayer disposed within the collection chamber, the sprayer being in fluid communication with the pump and comprising at least one nozzle alignable for spray contact with the filter media; and;
wherein when water is pumped from the sump to the sprayer, the water is sprayed across the filter media to remove any debris thereon.

2. The dishwasher of claim 1, further including a drain pump in communication with the collection chamber for drainage of debris from the collection chamber.

3. The dishwasher of claim 1 wherein the sprayer comprises a conduit extending upwardly from the bottom of the collection chamber.

4. The dishwasher of claim 3 wherein the conduit comprises a tube.

5. The dishwasher of claim 4 further including a plurality of spaced apertures formed through the tube.

6. The dishwasher of claim 5 wherein at least some of the plurality of spaced apertures are vertically spaced.

7. The dishwasher of claim 1, further including a flow control device that is selectively positionable to direct at least some of the water to the sprayer.

8. The dishwasher of claim 1, further including:
a lower spray arm in communication with the pump; and
an upper spray arm in communication with the pump.

9. The dishwasher of claim 8, further including:
a multi-position flow control device downstream of the pump discharge; and
wherein the multi-position flow control valve is selectively positionable to direct the water to at least one of the sprayer, lower spray arm, and upper spray arm.

10. The dishwasher of claim 9, wherein the multi-position flow control valve is selectively positionable to direct all the water from the pump to the sprayer.

11. A method of operating a dishwasher to remove debris build-up from surfaces of a filter disposed in a collection chamber, the method comprising:
pumping filtered water to a sprayer with the collection chamber, the sprayer having a plurality of spaced nozzles aligned toward the filter; and
spraying the filtered water from the nozzles across the filter to remove the debris build-up from the filter.

12. A method of controlling the flow of circulated, filtered water in a dishwasher having at least one spray arm and a sprayer disposed within a collection chamber of the dishwasher, the method comprising the steps of:
pumping filtered water through a pump;
selectively directing the filtered water to at least one of the sprayer and the at least one spray arm.

13. The method of claim 12 wherein the at least one spray arm comprises a lower spray; and an upper spray arm.

14. The method of claim 13 wherein all of the filtered water is directed to the sprayer, to the upper spray arm, or to the lower spray arm.

15. The method of claim 13 wherein all of the filtered water is directed to at least one of the upper spray arm or the lower spray arm.

16. The method of claim 12 wherein selectively directing occurs by manipulating a multi-position flow control valve.

17. The method of claim 12 wherein when all of the filtered water is directed to the sprayer, a higher flow rate is obtained to sweep debris from a primary filter to the collection chamber.
